(19) United States
(12) Patent Application Publication
(10) Pub. No.: US 2008/0138083 A1
(43) Pub. Date: Jun. 12, 2008

(54) METHOD AND APPARATUS FOR EXTRACTING OPTICAL CLOCK SIGNAL

(75) Inventors: Jaemyoung Lee, Seoul (KR); Je Soo Ko, Daejeon (KR)

Correspondence Address: RABIN & Berdo, PC, 1101 14TH STREET, NW, SUITE 500, WASHINGTON, DC, 20005, US

(73) Assignee: ELECTRONICS & TELECOMMUNICATIONS RESEARCH INSTITUTE, Daejeon (KR)

(21) Appl. No.: 11/928,193

(22) Filed: Oct. 30, 2007

(30) Foreign Application Priority Data
Dec. 6, 2006 (KR) 10-2006-0123405

(51) Int. Cl. H04B 10/00

(52) U.S. Cl. 398/155

(57) ABSTRACT

Provided are a method and an apparatus for optically extracting a clock signal, that can be realized at low costs while minimizing an influence by input patterns and noises. In the method, optical signals having predetermined wavelength components are extracted using two FBG filters in order to extract a clock component from an input optical signal. After that, an influence by input filters is minimized by passing the extracted optical signals having the predetermined wavelengths through a Fabry-Perot filter.

### CLAIM OF PRIORITY

This application claims the benefit of Korean Patent Application No. 2006-0123405 filed on Dec. 6, 2006 in the Korean Intellectual Property Office, the disclosure of which is incorporated herein by reference.

### BACKGROUND OF THE INVENTION

1. Field of the Invention

The present invention relates to a method and an apparatus for optically extracting a clock signal, which it can be realized at low costs while minimizing an influence by input patterns and noises.

This invention was supported by the IT R&D program of MIC/IITA [2006-S-060-01, Program title: OTH-based 40G Multi-service transmission technology]

2. Description of the Related Art

Improvement of data transmission speed in an optical communication system has required improvement of a signal processing rate at a receiving terminal for receiving a transmitted signal and recovering the transmitted signal to an original signal together with technology development of a transmitting terminal converting desired data into an optical signal.

It is required to accurately and fast extract a clock used for data demodulation of a transmitted signal in order to improve a signal processing rate at the receiving terminal. Optical clock extracting technology has been studied as an alternative to meet this requirement.

Examples of a current method for optically extracting a clock include a method using self-pulsating occurring at a laser diode, and a method using an optical loop mirror. However, there are problems such as a difficulty in manufacturing a device for accurately extracting a desired clock, and instability of an optical system.

For one of proposed methods for solving these problems, there is a method for recovering a clock signal using a predetermined wavelength component existing on a light spectrum. This method obtains a clock signal by extracting two adjacent wavelength components corresponding to a data transmission rate of a received signal and generating beating.

In more detail, examination of a light spectrum of a received optical signal shows that there are spectral lines having a relatively larger value as illustrate in the graph (a) of FIG. 1. Wavelengths (i.e., wavelengths 1 and 2, or wavelengths 2 and 3) of adjacent spectral lines corresponding to a data transmission rate are extracted, sizes of signals of the extracted wavelengths are made same, and the signals are processed to generate beat. A signal generated by this beat is output as a clock signal.

At this point, a tunable bandpass filter 10 has been used in order to make the same the sizes of wavelengths extracted from a received optical signal as illustrated in FIG. 1.

FIG. 1 (c) illustrates a light spectrum of a signal that has passed through the tunable bandpass filter 10 and the wavelengths 1 and 2 are controlled to have the same size.

However, in the case where the tunable bandpass filter is used as in the conventional art, a small noise component existing between extracted two wavelength components is also transmitted, so that an entire signal-to-noise ratio (SNR) is reduced, and a clock signal extracting apparatus is complicated.

Also, there is a problem that a clock signal that is being recovered instantly vanishes depending on an input optical signal pattern.

### SUMMARY OF THE INVENTION

The present invention has been made to solve the foregoing problems of the prior art and therefore an object according to certain embodiments is to provide a method and an apparatus for optically extracting a clock signal, that can be realized at low costs while minimizing an influence by input patterns and noises of an input optical signal.

According to an aspect of the invention, the invention provides a method for optically extracting a clock signal, the method including: extracting signals of a first wavelength and a second wavelength set in advance in order to extract a clock component from a received optical signal; applying the extracted optical signals to a Fabry-Perot filter where an FSR (free spectral region) is set to correspond to a data rate of the received optical signal, and passing the signals through the Fabry-Perot filter; controlling the signals of the first and second wavelengths output from the Fabry-Perot filter to have a constant size; and generating a beating using the signals of the first and second wavelengths to extract a clock signal.

According to an embodiment of the invention, the method may further include, before the applying of the extracted optical signals to the Fabry-Perot filter, amplifying the extracted signals.

According to an embodiment of the invention, the controlling of the signals of the first and second wavelengths includes amplifying the signals of the first and second wavelengths in a saturated region of an SOA (semiconductor optical amplifier).

According to an embodiment of the invention, the method may further include, before the generating of the beating using the signals of the first and second wavelengths, removing a noise generated at the SOA.

According to another aspect of the invention for realizing the object, there is provided an apparatus for optically extracting a clock signal to recover the clock signal through a beating between two wavelength components contained in a received optical signal, the apparatus including: a wavelength selecting unit for extracting signals of a first wavelength and a second wavelength set in advance for extraction of a clock component from a received optical signal; and an Fabry-Perot filter where an FSR is realized to be the same as a data transmission rate of the received optical signal, for passing only the signals of the first and second wavelengths from the extracted signals, and minimizing an influence by noises and received patterns.

According to an embodiment of the invention, the apparatus may further include an optical amplifier for amplifying signals extracted by the wavelength selecting unit to deliver the amplified signals to the Fabry-Perot filter.

According to an embodiment of the invention, the apparatus may further include an SOA operating in a saturated region to control a signal from the Fabry-Perot filter to a predetermined size. At this point, the SOA has a gain set such that the signals from the Fabry-Perot filter has an input size within the saturated region of the SOA.

According to an embodiment of the invention, the apparatus may further include a bandpass filter for filtering signals output from the SOA and having predetermined wavelength components to remove noises generated during the amplifying.

According to an embodiment of the invention, the wavelength selecting unit includes: a circulator having a first port, a second port, and a third port, to receive a reception optical signal via the first port and output the received optical signal to the second port, and output an optical signal received to the second port to the third port; a first optical filter connected to the second port of the circulator to reflect a first wavelength component of received optical signals to the second port; a second optical filter for reflecting a second wavelength component of optical signals that have passed through the first optical filter to output the second wavelength component to the second port via the first optical filter; and a variable optical attenuator connected between the first optical filter and the second optical filter to attenuate a signal having a second wavelength applied from one of the first optical filter and the second optical filter.

At this point, preferably each of the first and second optical filters may comprise an optical Bragg grating, and the variable optical attenuator may have an attenuation rate set such that a size of a signal having the second wavelength is equal to that of a signal having the first wavelength.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a conventional method for optically extracting a clock signal;

FIG. 2 is a flowchart illustrating a method for optically extracting a clock signal according to the present invention;

FIG. 3 is a block diagram of an apparatus for optically extracting a clock signal according to the present invention;

FIG. 4 is a graph illustrating a wavelength characteristic of a Fabry-Perot filter; and

FIG. 5 is a graph illustrating a gain characteristic of a semiconductor optical amplifier (SOA).

### DETAILED DESCRIPTION OF THE PREFERRED EMBODIMENT

Certain or exemplary embodiments of the present invention will now be described in detail with reference to the accompanying drawings. However, in description of operation principles associated with the embodiments of the present invention, detailed description of a known art or construction is omitted because it may obscure the spirit of the present invention unnecessarily.

Also, like reference numerals refer to like elements throughout the specification.

A none-return to zone (NRZ) electrical signal has no clock component, but an optically modulated NRZ signal has a clock component. The present invention extracts wavelength components existing in an optically modulated NRZ signal and corresponding to a data transmission rate, and generates a beating using the extracted wavelength components to recover a clock signal. In this case, a problem that neighboring noises can be selected together when a predetermined wavelength component is obtained using a filter, and a problem that a clock signal to be recovered can instantly vanish depending on input patterns should be considered.

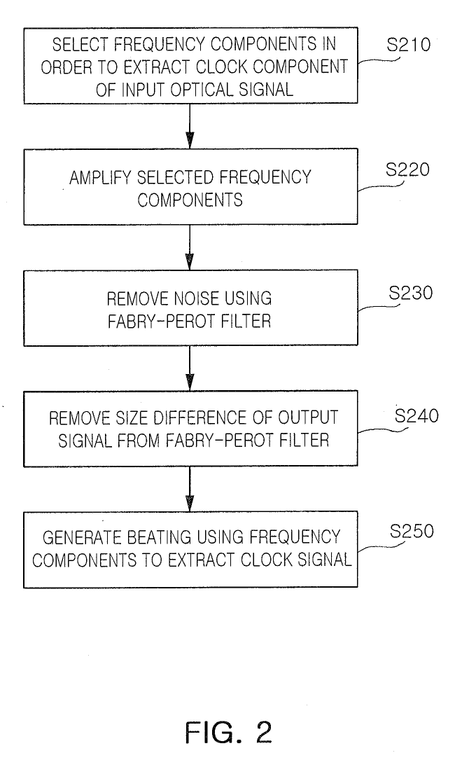

The present invention solves an influence by the above-described noises and input patterns. FIG. 2 is a flowchart illustrating a method for optically extracting a clock signal according to the present invention.

Referring to FIG. 2, the method for optically extracting a clock signal includes: extracting (S210) optical signals of a first wavelength and a second wavelength set in advance in order to extract a clock component from an input optical signal; passing (S230) the extracted optical signals of the first wavelength and the second wavelength through a Fabry-Perot filter having a free spectral range (FSR) corresponding to a data transmission rate of the input optical signal; removing (S240) a size difference between wavelength components of optical signals output from the Fabry-Perot filter; and generating (S250) a beating using wavelength components whose size difference has been removed.

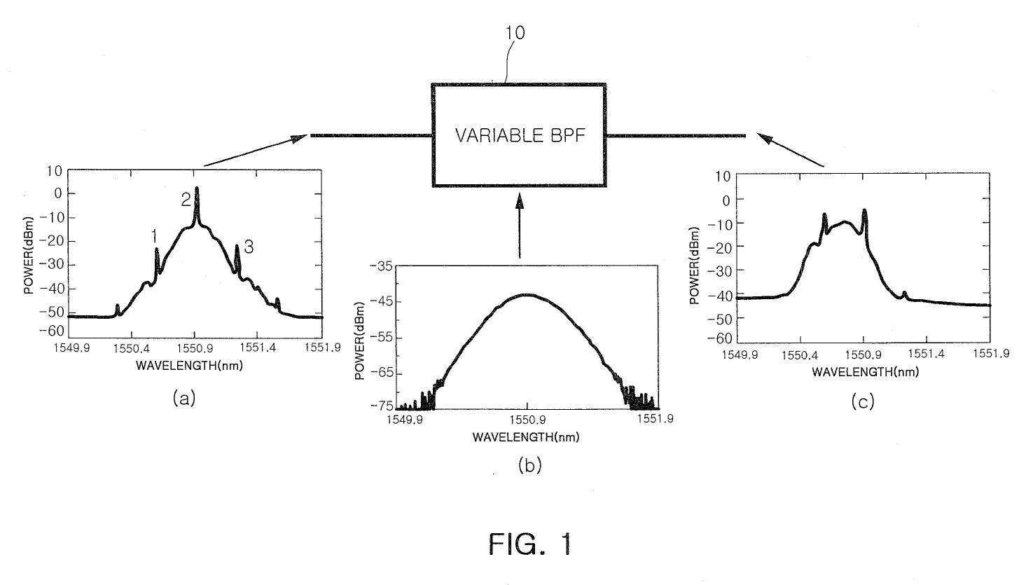

In S210, signals of the first wavelength and the second wavelength required for recovering a clock are extracted from an input optical signal (i.e., an NRZ signal) using an optical Bragg grating (FBG). That is, the signals of the first wavelength and the second wavelength set in advance to correspond to a corresponding data transmission rate are extracted from an optical signal input using two optical FBG filters set to reflect the signals of the first wavelength and the second wavelength. At this point, the signal having the first wavelength is denoted by ‘1’ or ‘3’ in FIG. 1 (a). The signal having the second wavelength is a signal of a central wavelength denoted by ‘2’ in FIG. 1 (a). That is, the signal having the first wavelength has a size different from that of the signal having the second wavelength. Accordingly, the method further includes attenuating the size of the signal having the second wavelength to a degree of the size of the signal having the first wavelength using an attenuator such that the above-extracted signals maintain a predetermined size.

Additionally, the method further includes, when intensities of the signals of the first and second wavelengths extracted in S210 are weak, amplifying (S220) the signals of the first and second wavelengths before the passing (S230) of the extracted optical signals through the Fabry-Perot filter.

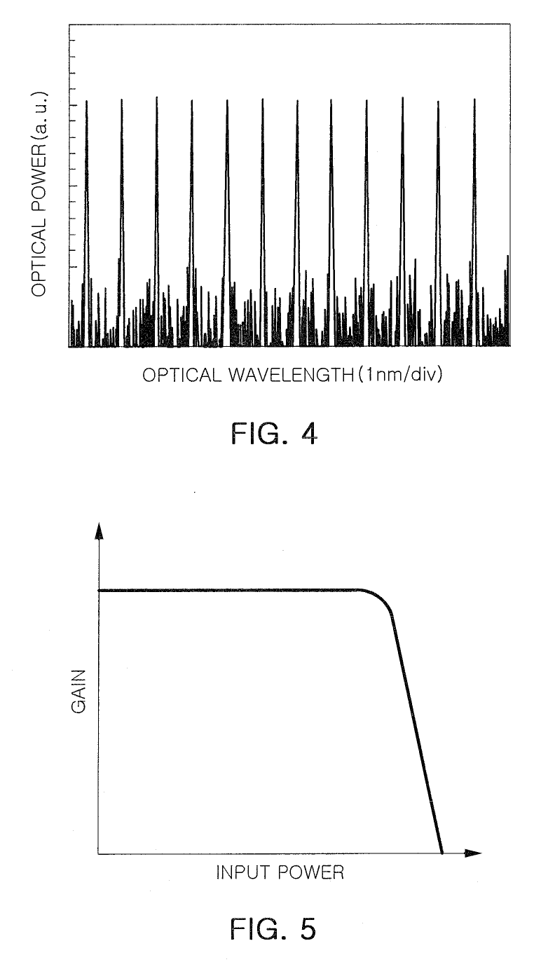

S230 is for removing or reducing an influence by input signal patterns when a clock signal is extracted using the Fabry-Perot filter. The Fabry-Perot filter is an optical device using a fact that an optical signal of a predetermined wavelength resonates when two flat mirrors are disposed in parallel inside an optical fiber. A signal input to the Fabry-Perot filter can maintain a state of a signal ‘1’ for a predetermined time in a cavity using a mirror of the cavity formed inside the Fabry-Perot filter. This provides the same effect of inserting a value ‘1’ into a time slot having a value ‘0’ in the case where an input signal has a continuous value ‘0’. Through this operation, a problem that a clock signal vanishes depending on input signal patterns can be reduced. The Fabry-Perot filter extracts a clock component, and also removes noises generated during the amplifying in the case where an optical signal of a selected wavelength is amplified in S220. FIG. 4 is a graph illustrating a wavelength characteristic of a Fabry-Perot filter.

The sizes of signals of a wavelength that have passed through the Fabry-Perot filter can change depending on time. S240 is for removing this size difference. In more detail, the sizes of the signals of the first and second wavelengths are controlled such that an SOA operates in its saturated region, and the size-controlled signals are allowed to pass through the SOA to minimize variations in size of a clock signal depending on time. FIG. 5 is a graph illustrating a gain characteristic of an SOA. Referring to FIG. 5, input power shows a constant gain when the size of the input power increases to a predetermined value, but the grain drastically reduces when the size of the input power exceeds the predetermined value. That is, in the case where the size of a signal input to the SOA is located in the saturated region of the SOA, a great gain is obtained when the size of the input signal is relatively small. On the other hand, when the size of the input signal is relatively large, a small gain is obtained. Therefore, an effect that a signal that passes through the SOA has a constant size can be obtained.

Next, in S250, the signals of two wavelengths that have passed through the SOA are used to generate a beating, so that a clock signal of a constant size is extracted.

Additionally, the method for optically extracting a clock signal according to the present invention can further include, before the generating (S250) of the beating using wavelength components, removing noises that can be generated by the SOA and included during the removing (S240) of the size difference between wavelength components.

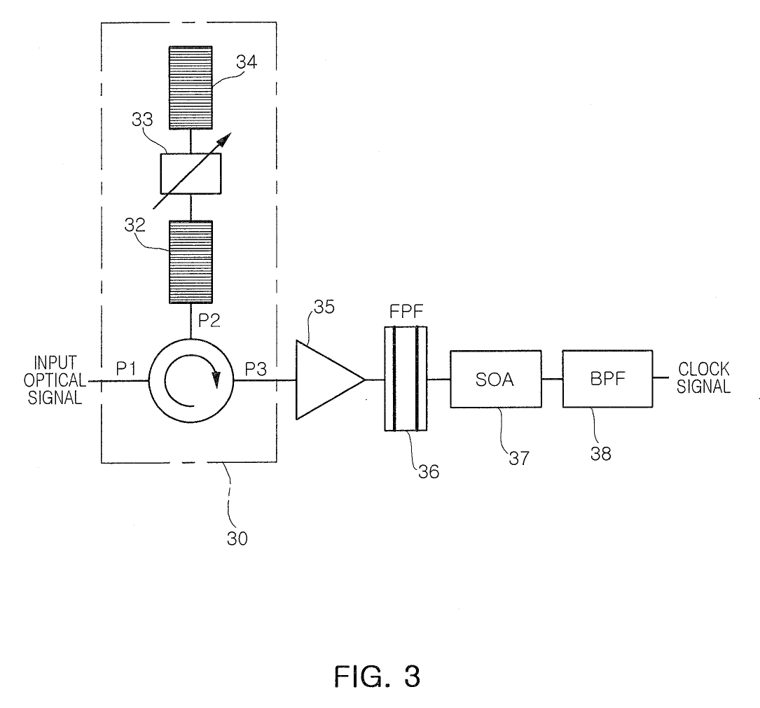

FIG. 3 is a block diagram of an apparatus for optically extracting a clock signal according to the present invention.

Referring to FIG. 3, the apparatus basically includes: a wavelength selecting unit 30 for extracting signals of a first wavelength and a second wavelength set in advance for extraction of a clock component from an input optical signal; an optical amplifier 35 for amplifying the signals of the first and second wavelengths selected and output by the wavelength selecting unit 30; a Fabry-Perot filter 36 where an FSR is realized to be the same as a data transmission rate of the input optical signal, for passing only the signals having the first and second wavelengths of the signals amplified by the optical amplifier 35; and an SOA 37 for operating in a saturated region to control signals output from the Fabry-Perot filter 36 to a predetermined size.

Additionally, the apparatus further includes a bandpass filter 38 for filtering a signal output from the SOA 37 to remove noises generated during the amplifying.

Though omitted in FIG. 3, signals of the two wavelength components extracted from the apparatus for optically extracting the clock signal are used to generate a beating. A clock signal is generated by the beating.

The wavelength selecting unit 30 includes: a circulator 31 having a first port, a second port, and a third port, receiving a reception optical signal via the first port to output the received optical signal to the second port, and outputting an optical signal received to the second port to the third port; a first optical filter 32 connected to the second port of the circulator 31 to reflect a signal having a first wavelength of received optical signals to the second port; a second optical filter 34 for reflecting a signal having a second wavelength of optical signals that have passed through the first optical filter 32 to output a signal having the second wavelength to the second port via the first optical filter 32; and a variable optical attenuator 33 connected between the first optical filter 32 and the second optical filter 34 to attenuate the size of a signal having the second wavelength applied from one of the first optical filter 32 and the second optical filter 34. The signal having the second wavelength is a signal of a wavelength (corresponding to a signal of a central frequency) denoted by ‘2’ in the spectrum diagram of FIG. 1 (a). The signal having the first wavelength is a signal of a wavelength that is smaller than the second wavelength denoted by ‘1’ or ‘3’ in the spectrum diagram of FIG. 1 (a).

Each of the first and second optical filters 32 and 34 is a fiber Bragg grating (FBG) filter.

The apparatus for optically extracting the clock signal uses the FBG filter and the Fabry-Perot filter in order to extract a predetermined wavelength component from a received NRZ optical signal.

Particularly, the wavelength selecting unit 30 obtains two wavelength components required for recovering a clock using the first and second optical filters 32 and 34, which are two FBG filters.

That is, when a reception optical signal is input to the first port P1 of the circulator 31, the optical signal propagates to the second port P2 of the circulator 32. At this point, the propagating optical signal has an optical spectrum illustrated in FIG. 1 (a).

The optical signal propagating to the second port P2 of the circulator 31 is provided to the first optical filter 32. At this point, a signal having a first wavelength is reflected by the first optical filter 32 and provided back to the second port P2 of the circulator 31. Also, a signal having a second wavelength of the propagating optical signal is not reflected by the first optical filter 32 and directly passes through the first optical filter 32, and is incident to the second optical filter 34. At this point, the size of the signal having the second wavelength is attenuated while it passes through the variable optical attenuator 33. Also, the signal having the second wavelength is reflected by the second optical filter 34, passes through the variable optical attenuator 33 and the first optical filter 32, and propagates to the second port P2 of the circulator 31.

At this point, the signal having the second wavelength passes through the variable optical attenuator 33 two times. Therefore, assuming that an attenuation rate of the variable optical attenuator 33 is ‘a’, the signal having the second wavelength experiences attenuation of a². That is, the attenuation rate of the variable optical attenuator 33 is set to have total attenuation such that the size of the signal having the second wavelength is equal to that of the signal of the first wavelength.

Optical signals having a wavelength selected by the reflection type first and second optical filters 32 and 34 are output to the third port by the circulator 31, and provided to the Fabry-Perot filter 36 manufactured such that an FSR is equal to a data transmission rate of the received optical signal.

At this point, when the sizes of optical signals provided to the Fabry-Perot filter 36 are too small, the signals are amplified at the optical amplifier 35 so that the SOA 37 at the rear end operates in a saturated region in order to increase the size of the optical signals.

The Fabry-Perot filter 36 showing a characteristic illustrated in FIG. 4 removes noises between the signal having the first wavelength and the signal having the second wavelength, and selects only signals having the first and second wavelengths. Also, the Fabry-Perot filter 36 removes even noises generated by the optical amplifier 35.

The sizes of signals that have passed through the Fabry-Perot filter 36 are controlled by the SOA 37. Signals having a large size are amplified using a small gain, and signals having a small size are amplified using a large gain while the signals pass through the SOA 37 having a gain characteristic illustrated in FIG. 5, so that the signals are controlled to signals having a uniform size. For this purpose, the optical amplifier 35 amplifies the signals such that the signals that are output from the Fabry-Perot filter 36 and provided to the SOA 37 have a size that can be applied to a saturated region of the SOA 37. Accordingly, a size difference depending on a time band generated while signals pass through the Fabry-Perot filter 36 can be removed.

Noises that can be generated at the SOA 37 are removed while the signals that have passed through the SOA 37 pass through the BPF 38. Signals output from the BPF 38 are used to generate a beating at a receiver at the rear end. The beating is used to recover a clock signal.

According to the present invention, the apparatus for optically extracting the clock signal minimizes an influence caused by noises and input patterns to extract an accurate clock signal.

As described above, the present invention reduces an influence of noises on a recovered clock by accurately selecting only a wavelength component required for recovering the clock signal from a received optical signal, solves a problem that the clock signal vanishes depending on input signal patterns, and minimizes a size difference of a clock signal depending on time.

While the present invention has been shown and described in connection with the preferred embodiments, it will be apparent to those skilled in the art that modifications and variations can be made without departing from the spirit and scope of the invention as defined by the appended claims.

What is claimed is:

1. A method for optically extracting a clock signal, the method comprising:
extracting signals of a first wavelength and a second wavelength set in advance in order to extract a clock component from a received optical signal;
applying the extracted optical signals to a Fabry-Perot filter where an FSR (free spectrum region) is set to correspond to a data rate of the received optical signal, and passing the signals through the Fabry-Perot filter;
controlling the signals of the first and second wavelengths output from the Fabry-Perot filter to have a constant size; and
generating a beating using the signals of the first and second wavelengths to extract a clock signal.

2. The method according to claim 1, further comprising, before the applying of the extracted optical signals to the Fabry-Perot filter, amplifying the extracted signals.

3. The method according to claim 1, wherein the controlling of the signals of the first and second wavelengths comprises amplifying the signals of the first and second wavelengths in a saturated region of an SOA (semiconductor optical amplifier).

4. The method according to claim 3, further comprising, before the generating of the beating using the signals of the first and second wavelengths, removing noises generated at the SOA.

5. An apparatus for optically extracting a clock signal to recover the clock signal through a beating of two wavelength components contained in a received optical signal, the apparatus comprising:
a wavelength selecting unit for extracting signals of a first wavelength and a second wavelength set in advance for extraction of a clock component from a received optical signal; and
a Fabry-Perot filter where an FSR is realized to be the same as a data transmission rate of the received optical signal, for passing only the signals of the first and second wavelengths from the extracted signals, and minimizing an influence by noises and received patterns.

6. The apparatus according to claim 5, further comprising an optical amplifier for amplifying signals extracted by the wavelength selecting unit to deliver the amplified signals to the Fabry-Perot filter.

7. The apparatus according to claim 6, further comprising an SOA operating in a saturated region to control a signal from the Fabry-Perot filter to have a constant size.

8. The apparatus according to claim 7, wherein the optical amplifier has a gain set such that the signals from the Fabry-Perot filter has an input size within the saturated region of the SOA.

9. The apparatus according to claim 7, further comprising a BPF (bandpass filter) for filtering signals output from the SOA and having predetermined wavelength components to remove noises generated during the amplifying.

10. The apparatus according to claim 7, wherein the wavelength selecting unit comprises:
a circulator having a first port, a second port, and a third port, to receive a reception optical signal via the first port and output the received optical signal to the second port, and output an optical signal received to the second port to the third port;
a first optical filter connected to the second port of the circulator to reflect a signal having a first wavelength of received optical signals to the second port;
a second optical filter for reflecting a signal having a second wavelength of optical signals that have passed through the first optical filter to output a signal having the second wavelength to the second port via the first optical filter; and
a variable optical attenuator connected between the first optical filter and the second optical filter to attenuate a size of a signal having the second wavelength applied from one of the first optical filter and the second optical filter.

11. The apparatus according to claim 10, wherein each of the first and second optical filters comprises an optical Bragg grating filter.

12. The apparatus according to claim 10, wherein the variable optical attenuator has an attenuation rate set such that a size of a signal having the second wavelength is equal to that of a signal having the first wavelength.
